(19) United States
(12) Patent Application Publication
(10) Pub. No.: US 2025/0378998 A1
(43) Pub. Date: Dec. 11, 2025

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventors: Youichi MIZUNO, Takasaki-shi (JP); Takashi SASAKI, Takasaki-shi (JP); Yusuke KOWASE, Takasaki-shi (JP); Hidetoshi MASUDA, Takasaki-shi (JP)

(21) Appl. No.: 19/283,971

(22) Filed: Jul. 29, 2025

Related U.S. Application Data
(63) Continuation of application No. PCT/JP2024/001285, filed on Jan. 18, 2024.

(30) Foreign Application Priority Data
Feb. 28, 2023 (JP) 2023-029436

(51) Int. Cl. H01G 4/30; H01G 4/012; H01G 4/232

(52) U.S. Cl. CPC H01G 4/30; H01G 4/012; H01G 4/232

(57) ABSTRACT

A multilayer ceramic electronic component includes a ceramic element having dielectric layers and internal electrodes alternately laminated in a first axis direction, a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction, and a pair of external electrodes respectively provided at end portions of the ceramic element in the third axis direction and electrically connected to the internal electrodes. The internal electrode includes a diffusion region including a metal different from a main component of the internal electrode in at least a portion of an outer peripheral portion thereof.

### CROSS-REFERENCE TO RELATED APPLICATION

This application is based upon and claims the benefit of priority of the prior International Patent Application No. PCT/JP2024/001285, filed on Jan. 18, 2024, which claims the benefits of priorities of Japanese Patent Application No. 2023-029436 filed on Feb. 28, 2023, the entire contents of which are incorporated herein by reference.

### FIELD

A certain aspect of the present invention relates to a multilayer ceramic electronic component and a method of manufacturing the same.

### BACKGROUND

A multilayer ceramic capacitor, which is one of multilayer ceramic electronic components, includes a multilayer body in which a plurality of dielectric layers and a plurality of internal electrodes are alternately laminated, and a pair of external electrodes formed on a surface of the multilayer body so as to be electrically connected to the internal electrodes led out to a surface of the multilayer body. The external electrode is formed by plating on a base layer. Japanese Unexamined Patent Application Publication No. Hei 1-80011 describes that hydrogen generated during plating is occluded in the internal electrodes and reduces the dielectric layer, thereby deteriorating the insulation resistance. In addition, Japanese Unexamined Patent Application Publication No. Hei 1-80011 describes that Ni (nickel) is added as a metal that suppresses absorption of hydrogen when an internal electrode containing a noble metal as a main component is used. On the other hand, Japanese Unexamined Patent Application Publication No. 2016-66783 describes that even when Ni is used for the internal electrode, the insulation resistance is deteriorated due to the influence of hydrogen.

### SUMMARY OF THE INVENTION

(1) According to an aspect of the present disclosure, there is provided a multilayer ceramic electronic component including: a ceramic element having dielectric layers and internal electrodes alternately laminated in a first axis direction, a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction; a pair of external electrodes respectively provided at end portions of the ceramic element in the third axis direction and electrically connected to the internal electrodes respectively led out to the end portions of the ceramic element in the third axis direction; a metal containing portion provided in contact with an outer peripheral portion of the internal electrode when viewed from the first axis direction, and formed of a material containing a metal, as a main component, different from a main component of the internal electrode; and an outer peripheral dielectric portion provided between the dielectric layers respectively disposed on an upper surface and a lower surface of the internal electrode along the first axis direction, provided in contact with an outer peripheral portion of the metal containing portion not in contact with the internal electrode when viewed from the first axis direction, and formed of a material having a composition different from that of the metal containing portion, wherein the internal electrode includes a diffusion region including a metal different from a main component of the internal electrode in at least a portion of an outer peripheral portion of the internal electrode, the diffusion region is formed at an end portion of the internal electrode in the second axis direction in a cross section parallel to a plane including the first axis direction and the second axis direction, or is formed at an end portion of the internal electrode in the third axis direction in a cross section parallel to a plane including the first axis direction and the third axis direction, and a concentration of any element of Pt, Pd, Au, Ag, Cu, Sn, Fe, Zn, or Al in the diffusion region is higher than that in the upper surface and the lower surface of the internal electrode.
(2) In the multilayer ceramic electronic component according to the above (1), when the diffusion region is formed at the end portion of the internal electrode in the second axis direction in the cross section parallel to the plane including the first axis direction and the second axis direction, a size of the diffusion region in a direction along the second axis direction may be 0.1 nm or more and 37 μm or less.
(3) In the multilayer ceramic electronic component according to the above (1), when the diffusion region is provided at the end portion of the internal electrodes in the second axis direction in the cross section parallel to the plane including the first axis direction and the third axis direction, a size of the diffusion region in a direction along the third axis direction may be 0.1 nm or more and 37 μm or less.
(4) In the multilayer ceramic electronic component according to the above (1), the multilayer ceramic electronic component may have outer sizes of 2.8 mm or less in each of the first axis direction and the second axis direction and 6.1 mm or less in the third axis direction.
(5) In the multilayer ceramic electronic component according to the above (4), the internal electrode may contain Ni as a main component, and Ni is present in the diffusion region.
(6) In the multilayer ceramic electronic component according to the above (1), when the diffusion region is provided at the end portion of the internal electrodes in the second axis direction in the cross section parallel to the plane including the first axis direction and the third axis direction, a size of the diffusion region in a direction along the third axis direction may be 0.1 nm or more and 3.5 nm or less.
(7) In the multilayer ceramic electronic component according to the above (1), when the diffusion region is formed at an end portion of the internal electrode in the second axis direction in the cross section parallel to the plane including the first axis direction and the third axis direction, a size of the diffusion region in a direction along the third axis direction may be 0.8 μm or more and 18 μm or less.
(8) According to another aspect of the present disclosure, there is provided a method of manufacturing a multilayer ceramic electronic component, including: a first step of disposing an internal electrode pattern of a metal conductive paste on a green sheet containing main component ceramic particles; a second step of forming, as an additional printed portion, a metal containing portion including, together with the main component ceramic particles, at least a metal of Pt, Pd, Au, Ag, Cu, Sn, Fe, Zn, or Al, or an oxide of the metal in a peripheral region of the metal conductive paste on the green sheet, and providing, as a thickness compensation portion, an outer peripheral dielectric portion for compensating for a step between the internal electrode pattern and the additional printed portion in a periphery of the additional printed portion not in contact with the internal electrode; a third step of firing a ceramic laminate body obtained by laminating a plurality of lamination units obtained in the second step; and a fourth step of subjecting the ceramic laminate body obtained in the third step to a plating treatment to form an external electrode.

### BRIEF DESCRIPTION OF THE DRAWINGS

FIG. 1 is a perspective view of a multilayer ceramic capacitor according to an embodiment.

FIG. 2A is a cross-sectional view taken along line A-A in FIG. 1, FIG. 2B is an enlarged view of an end portion of a first internal electrode, and FIG. 2C is an enlarged view of an end portion of a second internal electrode.

FIG. 3 is a cross-sectional view taken along line B-B in FIG. 1.

FIG. 4A is a cross-sectional view taken along line C-C in FIG. 1, and FIG. 4B is an enlarged view of an end portion of an internal electrode.

FIG. 5 is a flowchart illustrating an example of a method for manufacturing the multilayer ceramic capacitor according to the embodiment.

FIGS. 6A and 6B are perspective views illustrating a part of a step included in a method of manufacturing a multilayer ceramic capacitor.

FIGS. 7A to 7C are explanatory views illustrating a part of a step included in another method of manufacturing a multilayer ceramic capacitor.

FIG. 8 is a cross-sectional view of a multilayer ceramic capacitor manufactured by a manufacturing method according to a variation, taken along a line corresponding to line B-B in FIG. 1.

### DETAILED DESCRIPTION

In order to suppress the influence of hydrogen, it is desirable to configure, for example, the internal electrode such that the insulation resistance is not reduced by hydrogen even when hydrogen enters from the external electrode.

In addition, in recent years, there has been an increasing demand for miniaturization of components, and for example, internal electrodes and external electrodes have to be designed to be close to each other, and in such a case, a countermeasure against current leakage between the internal electrodes and the external electrodes is desired.

An object of the present disclosure is to provide a multilayer ceramic electronic component that are able to prevent current leakage and destruction of the multilayer ceramic electronic component even when hydrogen enters the multilayer ceramic electronic component.

The present disclosure solves the above problems by disposing a dissimilar metal component on an outer peripheral portion of an internal electrode.

Hereinafter, a multilayer ceramic electronic component according to an embodiment of the present disclosure will be described with reference to the accompanying drawings. In the drawings, the dimensions, ratios, and the like of the respective parts may not be illustrated so as to completely match the actual ones. For convenience of drawing, details may be omitted or components themselves may be omitted depending on the drawings. In the drawings, an X-axis, a Y-axis, and a Z-axis orthogonal to each other are illustrated as appropriate. In the following description, a Z-axis direction corresponds to a first axis direction, and a Y-axis direction corresponds to a second axis direction. An X-axis direction corresponds to a third axis direction.

### Embodiment

### [Structure of Multilayer Ceramic Capacitor]

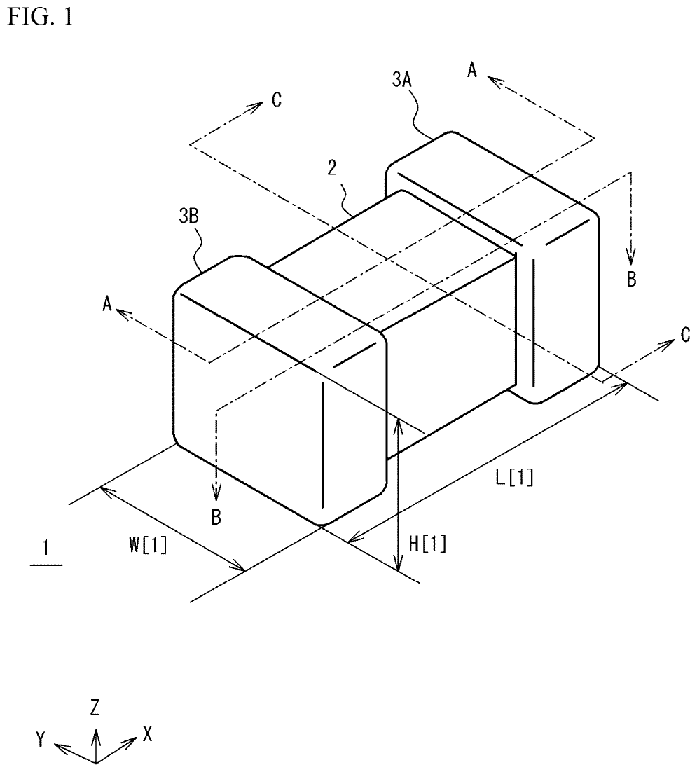

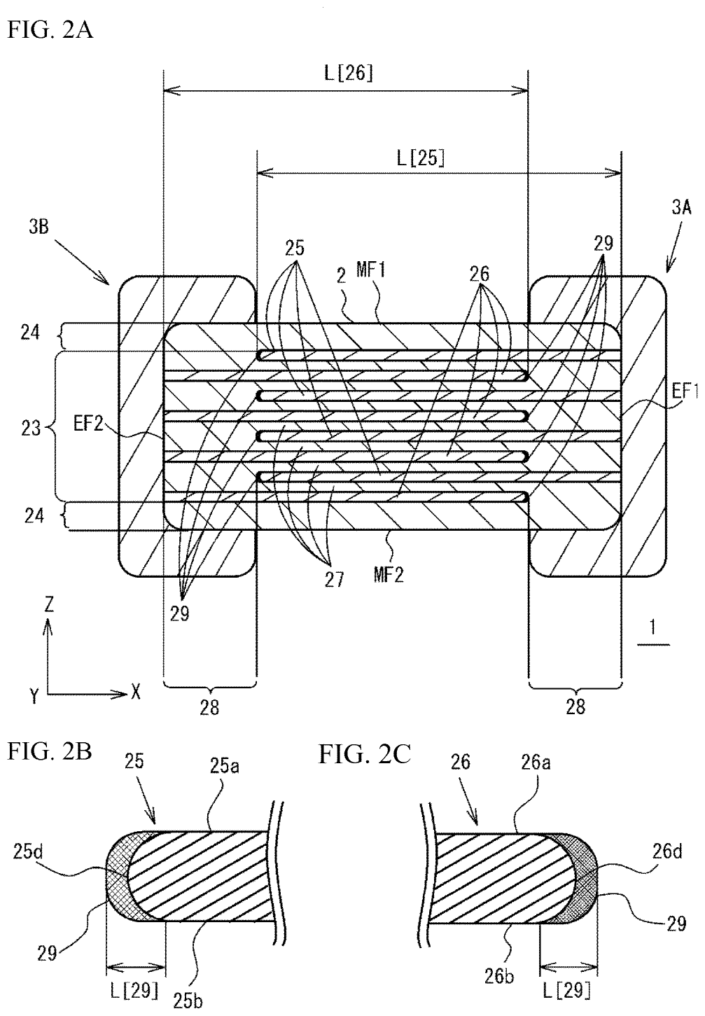

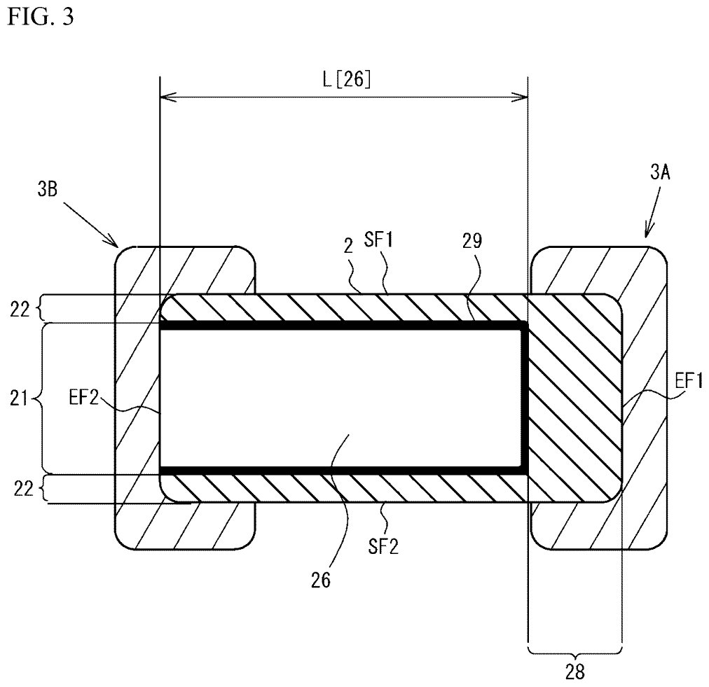

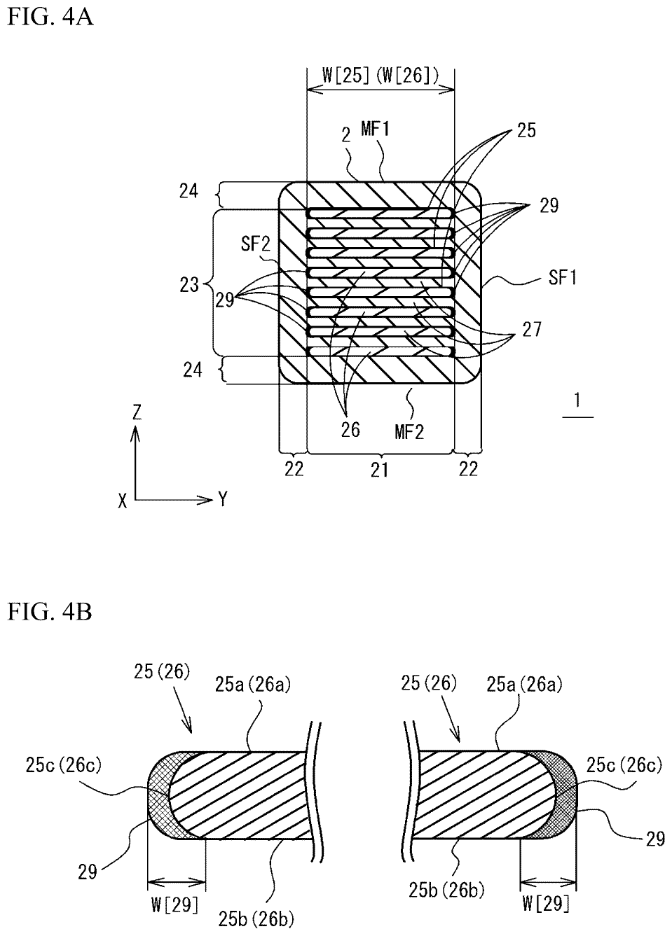

First, a multilayer ceramic capacitor (MLCC) 1 according to an embodiment will be described with reference to FIGS. 1 to 4B. FIG. 1 is a perspective view of a multilayer ceramic capacitor 1 according to the embodiment. FIG. 2A is a cross-sectional view taken along line A-A in FIG. 1. FIG. 2B is an enlarged view of an end portion of a first internal electrode 25. FIG. 2C is an enlarged view of an end portion of a second internal electrode 26. FIG. 3 is a cross-sectional view taken along line B-B in FIG. 1. FIG. 4A is a cross-sectional view taken along line C-C in FIG. 1, and FIG. 4B is an enlarged view of end portions of the first internal electrode 25 and the second internal electrode 26. In the multilayer ceramic capacitor 1, the X-axis direction is the length direction, the Y-axis direction is the width direction, and the Z-axis direction is the height direction.

The multilayer ceramic capacitor 1 includes a ceramic element 2, a first external electrode 3A provided at one end of the multilayer ceramic capacitor 1 in the length direction, and a second external electrode 3B provided at the other end of the multilayer ceramic capacitor 1.

The ceramic element 2 is formed as a hexahedron having first and second main surfaces MF1 and MF2 orthogonal to the Z-axis direction, first and second end surfaces EF1 and EF2 orthogonal to the X-axis direction, and first and second side surfaces SF1 and SF2 orthogonal to the Y-axis direction. The “hexahedron” may be substantially a hexahedron, and for example, ridges connecting the surfaces of the ceramic element 2 may be rounded.

The main surfaces MF1 and MF2, the end surfaces EF1 and EF2, and the side surfaces SF1 and SF2 of the ceramic element 2 are all formed as flat surfaces. The flat surface according to the present embodiment may not be strictly a plane as long as it is a surface recognized as flat when viewed as a whole, and includes, for example, a surface having a minute uneven shape of the surface, a gently curved shape existing in a predetermined range, or the like.

The ceramic element 2 includes a multilayer portion 21 and a pair of side margins 22. The multilayer portion 21 includes a capacitance forming portion 23 and a pair of cover layers 24. The capacitance forming portion 23 includes a plurality of first internal electrodes 25 and a plurality of second internal electrodes 26 that are alternately laminated with a plurality of dielectric layers 27 along the Z-axis direction. In the present embodiment, the first internal electrode 25, the second internal electrode 26, and the dielectric layer 27 are each configured in a sheet shape extending along the X-Y plane. The multilayer number of first internal electrodes 25 and the multilayer number of second internal electrodes 26 in each drawing does not represent the actual number of the multilayers.

The first internal electrode 25 and the second internal electrode 26 are alternately arranged along the Z-axis direction (height direction) so as to face each other in the Z-axis direction. The first internal electrode 25 and the second internal electrode 26 face each other in the Z-axis direction in an opposing region at the center in the X-axis direction and the Y-axis direction. The first internal electrodes 25 are led out from the opposing region to the end surface EF1 through an end margin 28 and connected to the first external electrode 3A. The second internal electrodes 26 are led out from the opposing region to the other end surface EF2 through the end margin 28 and connected to the second external electrode 3B.

The material of the first internal electrode 25 and the second internal electrode 26 can be selected from metals such as Ni (nickel), Cu (copper), Pd, Pt, Ag, or an alloy thereof as a main component.

The first internal electrode 25 and the second internal electrode 26 each includes a diffusion region 29 including a metal different from the main component of the internal electrodes in the outer peripheral portion thereof in a plan view when viewed from the Z-axis direction. The diffusion region 29 is formed in a portion in contact with the dielectric layer. The diffusion region 29 can suppress degradation of reliability due to penetration of hydrogen from the external electrodes 3A and 3B. That is, current leakage between the electrodes can be suppressed. The external electrodes 3A and 3B are formed by plating with the base electrodes, as will be described later. During the plating process, there is a concern that hydrogen is occluded in the internal electrode. When hydrogen is occluded in the internal electrode, the insulation resistance of the multilayer ceramic capacitor might deteriorate. The diffusion region 29 can suppress deterioration of the insulation resistance of such a component.

As the element contained in the diffusion region 29, in addition to the main component of the internal electrode, at least one element selected from platinum (Pt), palladium (Pd), gold (Au), silver (Ag), copper (Cu), tin (Sn), iron (Fe), zinc (Zn), and aluminum (Al) can be adopted.

The diffusion region 29 is provided at each of the end portion of the first internal electrode 25 and the end portion of the second internal electrode 26 illustrated in the cross section illustrated in FIG. 2A, that is, the X-Z plane. The diffusion region 29 is provided at each of the end portion of the first internal electrode 25 and the end portion of the second internal electrode 26 illustrated in the cross section illustrated in FIG. 4A, that is, the Y-Z plane. In the present embodiment, as in the second internal electrode 26 illustrated in FIG. 3, the diffusion region 29 is provided over the entire region of the periphery thereof. Although only the second internal electrode 26 is illustrated in FIG. 3, the diffusion region 29 is also provided over the entire region of the periphery of the first internal electrode 25. However, the diffusion region 29 may be provided in at least a part of the periphery of the first internal electrode 25 or the second internal electrode 26.

Referring to FIG. 2B, the diffusion region 29 covers an end surface 25d of the first internal electrodes 25, but does not reach an upper surface 25a and a lower surface 25b of the first internal electrodes 25. Similarly, referring to FIG. 2C, the diffusion region 29 covers an end surface 26d portion of the second internal electrode 26, but does not reach an upper surface 26a and a lower surface 26b of the second internal electrode 26. That is, the diffusion region 29 is formed at an end portion of the internal electrode in the third axis direction (X-axis direction), and the concentration of any one of the elements Pt, Pd, Au, Ag, Cu, Sn, Fe, Zn, and Al in the region of the end portion is higher than that on the upper surface and the lower surface of the internal electrode.

Referring to FIG. 4B, the diffusion region 29 covers a side surface 25c of the first internal electrode 25, but does not reach the upper surface 25a and the lower surface 25b of the first internal electrode 25. The same applies to the diffusion region 29 formed in the second internal electrode 26.

That is, the diffusion region 29 is formed so as not to rise above the upper surface 25a and the lower surface 25b of the first internal electrode 25 and the upper surface 26a and the lower surface 26b of the second internal electrode 26 and not to protrude from these surfaces. The diffusion region 29 is formed on at least a part of the end surface or the side surface of the internal electrode, and thus, deterioration of insulation resistance can be more efficiently suppressed with a small amount. The diffusion region 29 may be formed so as to extend to the upper surface 25a and the lower surface 25b of the first internal electrode 25 and the upper surface 26a and the lower surface 26b of the second internal electrode 26.

The diffusion region 29 is provided at the end portions of the first internal electrodes 25 and the second internal electrode 26 in this manner, and thus, it is possible to effectively suppress the occlusion of hydrogen.

As illustrated in FIG. 2B, a size L[29] of the diffusion region 29 in the direction along the X-axis direction may be 0.1 nm or more and 37 μm or less. Similarly, as illustrated in FIG. 4B, a size W[29] of the diffusion region 29 in the direction along the Y-axis direction may be 0.1 nm or more and 37 μm or less. Here, each of the size L[29] and the size W[29] is represented as a distance from a position close to the center portion of the internal electrode to the outermost portion in the diffusion region 29 illustrated in any cross section as illustrated in FIG. 2B and FIG. 4B. The sizes L[29] and W[29] can be more preferably 0.1 nm or more and 3.5 nm or less, or 0.8 μm or more and 18 μm or less. The upper limit of the size L[29] is set to 37 μm in consideration of the fact that the ESR increases when the size L[29] exceeds 37 μm, and therefore, the size L[29] is preferably set to 37 μm or less.

With this configuration, in the multilayer ceramic capacitor 1, when a voltage is applied between the first external electrode 3A and the second external electrode 3B, the voltage is applied to the plurality of dielectric layers 27 between the first internal electrodes 25 and the second internal electrodes 26 in the opposing region. Thus, in the multilayer ceramic capacitor 1, electric charges corresponding to the voltage between the first external electrode 3A and the second external electrode 3B are stored.

In the multilayer portion 21, a dielectric ceramic having a high dielectric constant is used in order to increase the capacitance of each dielectric layer 27 between the first internal electrode 25 and the second internal electrode 26. Examples of the dielectric ceramics having a high dielectric constant include materials having a perovskite structure containing barium (Ba) and titanium (Ti), typified by barium titanate (BaTiO₃).

The dielectric ceramics may be a composition system such as strontium titanate (SrTiO₃), calcium titanate (CaTiO₃), magnesium titanate (MgTiO₃), calcium zirconate (CaZrO₃), calcium zirconate titanate (Ca (Zr, Ti) O₃), barium calcium zirconate titanate ((Ba, Ca) (Zr, Ti) O₃), barium zirconate (BaZrO₃), and titanium oxide (TiO₂). Here, a low melting point metal may be added to the dielectric ceramics instead of the addition of the low melting point metal to the first internal electrode 25 and the second internal electrode 26, or together with the addition of the low melting point metal to the first internal electrode 25 and the second internal electrode 26.

The pair of cover layers 24 covers the capacitance forming portion 23 from both sides in the Z-axis direction as a laminating direction. The cover layer 24 may also be referred to as a protective layer in the height direction. The cover layer 24 is formed of, for example, a multilayer body having ceramic sheets extending along the X-Y plane. The dielectric ceramics constituting the cover layer 24 preferably has the same composition as the dielectric layer 27 from the viewpoint of suppressing internal stress and the like.

The pair of side margins 22 are formed along the Z-axis direction and cover the multilayer portion 21 from the Y-axis direction. The side margin 22 may be referred to as a protective layer in the width direction. The side margin 22 is formed on a surface of the multilayer portion 21 orthogonal to the Y-axis direction. The dielectric ceramics constituting the side margins 22 preferably has the same composition as the dielectric layers 27 from the viewpoint of reducing internal stress and the like.

The multilayer ceramic capacitor 1 includes the first external electrode 3A provided at one end of the multilayer ceramic capacitor 1 in the length direction (X-axis direction) and the second external electrode 3B provided at the other end of the multilayer ceramic capacitor 1.

In the first external electrode 3A and the second external electrode 3B, both the cross section parallel to the X-Z plane and the cross section parallel to the X-Y plane have a U shape. The shapes of the first external electrode 3A and the second external electrode 3B are not limited to the examples illustrated in the drawings.

The size of the multilayer ceramic capacitor 1 is not particularly limited, but for example, as designed values, any one of the sizes of 0.25 mm long, 0.125 mm wide, and 0.125 mm high (0201 size), 0.4 mm long, 0.2 mm wide, and 0.2 mm high (0402 size), 0.6 mm long, 0.3 mm wide, and 0.3 mm high (0603 size), 1.0 mm wide, 0.5 mm wide, and 0.5 mm high (1005 size), 3.2 mm wide, 1.6 mm wide, and 1.6 mm high (3216 size), 4.5 mm wide, 3.2 mm wide, and 2.5 mm high (4532 size), and 5.7 mm wide, 5.0 mm wide, and 2.3 mm high (5750 size) can be selected. The size of the multilayer ceramic capacitor 1 may be smaller than 0402 size, that is, any one of the length, width, and height of the multilayer ceramic capacitor 1 may be smaller than 0402 size. In addition, the widths and the heights may be 2.8 mm or less and the lengths may be 6.1 mm or less, respectively, including general manufacturing variations. In such a small-sized multilayer ceramic capacitor, a countermeasure against current leakage between electrodes is indispensable, but the multilayer ceramic capacitor 1 according to the present embodiment includes the diffusion region 29, and therefore, even when the multilayer ceramic capacitor 1 is downsized, occurrence of current leakage between electrodes can be suppressed.

### [Manufacturing Method]

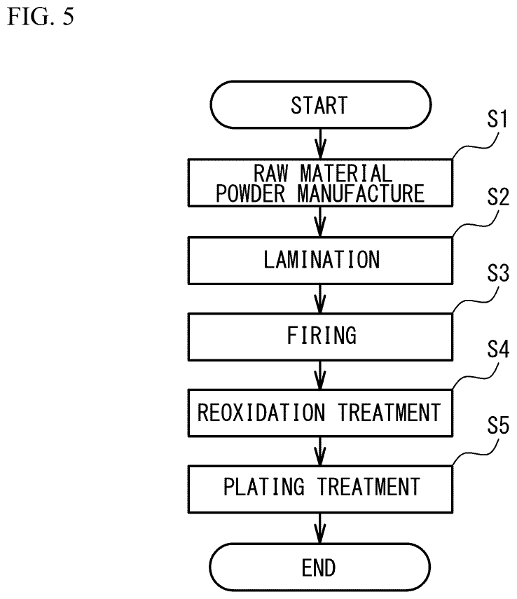

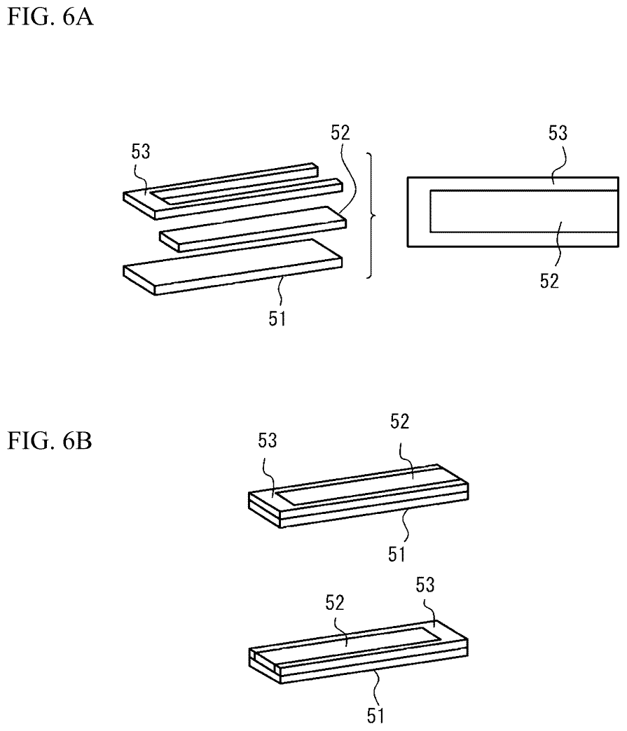

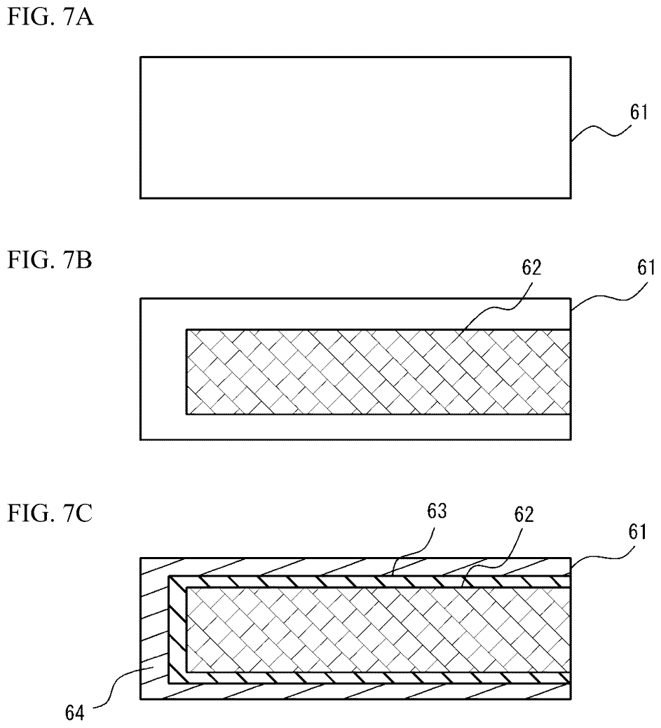

Next, an example of a method of manufacturing the multilayer ceramic capacitor 1 will be described with reference to FIGS. 5 to 7. FIG. 5 is a flowchart illustrating an example of a method of manufacturing the multilayer ceramic capacitor 1 according to the embodiment. FIGS. 6A and 6B are perspective views illustrating a part of a step included in the method of manufacturing the multilayer ceramic capacitor 1. FIGS. 7A to 7C are explanatory views illustrating a part of steps included in another method of manufacturing the multilayer ceramic capacitor 1.

### (Raw Material Powder Manufacturing Step)

In the low material powder manufacturing step in the step S1, first, a dielectric material for forming the dielectric layer 27 is prepared. An A-site element and a B-site element contained in the dielectric layer 27 are normally contained therein in the form of a sintered body of ABO₃ grains. For example, BaTiO₃ is a tetragonal compound having a perovskite structure and exhibits a high dielectric constant. In general, BaTiO₃ can be obtained by reacting a titanium raw material such as titanium dioxide with a barium raw material such as barium carbonate to synthesize barium titanate. As a method of synthesizing the ceramic constituting the dielectric layer 27, various methods are conventionally known, and for example, a solid phase method, a sol-gel method, a hydrothermal method, and the like are known. In the present embodiment, any of these can be adopted.

A predetermined additive is added to the obtained ceramic powder of barium titanate according to the purpose. Examples of the additive include rare earth elements such as dysprosium (Dy) and holmium (Ho), magnesium (Mg), vanadium (V), silicon (Si), and manganese (Mn). These additives can be added, for example, in the form of oxides of the respective elements, for example, as Ho₂ O₃, MgO, V₂ O₅, SiO₂, and Mn₃ O₄. These additives may be added in the step of synthesizing barium titanate.

In the present embodiment, first, as a raw material of barium titanate which is a main component constituting the dielectric layer 27, a compound containing an additive compound is mixed with powders of titanium dioxide and barium carbonate, and the mixture is pre-fired at 820 to 1150 degrees Celsius. Subsequently, the obtained ceramic particles are wet-mixed with an additive compound, dried, and pulverized to prepare a ceramic powder. For example, the average particle size of the ceramic powder is preferably 50 to 300 nm from the viewpoint of thinning the dielectric layer 27. For example, the ceramic powder obtained as described above may be subjected to a pulverization treatment to adjust the particle size, or may be subjected to a combination with a classification treatment to adjust the particle size, as necessary.

Next, a thickness compensation material for forming the side margins 22 and the end margin 28 is prepared. The thickness compensation material can be obtained by adding a predetermined additive to a ceramic powder containing barium titanate as a main component obtained by the same step as the step of manufacturing the dielectric material. As the predetermined additive, at least one metal of Pt, Pd, Au, Ag, Cu, Sn, Fe, Zn, and Al, or an oxide of these metals can be appropriately selected. These metals and oxides of these metals are diffused to the outer peripheral portion of the internal electrode in the firing step described later to form the diffusion region 29.

The amount of these predetermined additives is, for example, in the range of 0.01 wt % to 3.0 wt % when Ti of barium titanate is 100%. If the amount of the predetermined additive is less than 0.01 wt % when the Ti content of the barium titanate is 100%, the amount of the additive is not sufficient to diffuse into the outer peripheral portion of the internal electrode. If the content is more than 3.0 wt %, the composition amount deviates from the dielectric material as the main component, and thus cracks are likely to occur. The range of the amount of the predetermined additive can be determined in consideration of these factors.

For example, the average particle size of the thickness compensation material is preferably 50 to 300 nm, in accordance with the dielectric material. For example, the ceramic powder obtained as described above may be subjected to a pulverization treatment to adjust the particle size, or may be subjected to a combination with a classification treatment to adjust the particle size, as necessary.

### (Lamination Step)

Next, a binder such as polyvinyl butyral (PVB) resin, an organic solvent such as ethanol or toluene, and a plasticizer such as triethylene glycol are added to the obtained dielectric material and wet-mixed. The obtained slurry is used to coat a strip-shaped dielectric green sheet 51 (see FIG. 6A) having a thickness of, for example, 0.8 μm or less on a base material by, for example, a die coater method or a doctor blade method, and the dielectric green sheet 51 is dried.

Next, a metal conductive paste for forming internal electrodes containing an organic binder is printed on the surface of the dielectric green sheet 51 by screen printing, gravure printing, or the like, thereby disposing internal electrode patterns 52 (see FIG. 6A) alternately led out to a pair of external electrodes having different polarities. Ceramic particles may be added to the metal conductive paste as a co-material. The main component of the ceramic particles of the co-material is not particularly limited, but is preferably the same as the main component ceramic of the dielectric layer 27.

Next, a binder such as an ethyl cellulose type and an organic solvent such as a terpineol type were added to the thickness compensation material, and the mixture is kneaded by a roll mill to obtain a thickness compensation paste. On the dielectric green sheet 51, a thickness compensation paste is printed on a peripheral region where the internal electrode pattern 52 is not printed, thereby disposing a thickness compensation portion 53 (see FIG. 6A) and filling a step with the internal electrode pattern 52.

Thereafter, a predetermined number of layers (for example, 100 to 500 layers) are laminated so that internal electrode layers and dielectric layers are alternately arranged and the edges of the internal electrode layers are alternately exposed on both end surfaces of the dielectric layers in the length direction and alternately led out to the pair of external electrodes 3A and 3B having different polarities to be electrically connected thereto.

Cover sheets to be the cover layers 24 are pressure-bonded to the top and bottom of the laminated dielectric green sheets 51 to form a laminate. Although the description has been given of the state in which the laminate is cut into individual laminate units for easy understanding of the description, the laminate can be manufactured by a known method of laminating the laminate in a multi-piece manner and then cutting the laminate into individual pieces. Thereafter, a metallic conductive paste to be a base layer of the external electrodes 3A and 3B is applied to both side surfaces of the laminate by a dipping method or the like and dried.

Thus, a molded body of the multilayer ceramic capacitor 1 is obtained.

### (Firing Step)

The molded body thus obtained is subjected to a binder removal treatment in an N₂ atmosphere at 250 to 500 degrees Celsius, and then fired in a reduction atmosphere with a partial pressure of oxygen of 10⁻⁵ to 10⁻⁸ atm at 1100 to 1300 degrees Celsius for 10 minutes to 2 hours, whereby the respective compounds are sintered and the grains thereof grow. At this time, the metal such as Pt, Pd, Cu, Sn, Fe, Zn, or Al added to the thickness compensation material or the oxide thereof is diffused toward the outer peripheral portions of the first internal electrode 25 and the second internal electrode 26, thereby forming the diffusion regions 29.

The firing conditions can be set as appropriate to form the diffusion regions 29. That is, the conditions may be adjusted so that the metal component added to the thickness compensation material is diffused and present in the outer peripheral portions of the first internal electrode 25 and the second internal electrode 26 in the firing step. The metal component or the metal oxide is easily diffused to the outer peripheral portions of the first internal electrode 25 and the second internal electrode 26 by increasing the amount of the metal or the metal oxide to be added, increasing the firing temperature, or increasing the firing time.

### (Reoxidation Treatment Step)

Thereafter, reoxidation treatment may be performed at 600 degrees Celsius. to 1000 degrees Celsius. in an N₂ gas atmosphere.

### (Plating Treatment Step)

Thereafter, a plating treatment is performed on the base layer of the external electrode to form a plating layer. When the material of the base layer is nickel, it is preferable to form a copper plating layer, a nickel plating layer, and a tin plating layer. When the material of the base layer is copper, it is preferable to form a nickel plating layer and a tin plating layer. Thus, the external electrodes 3A and 3B each including the base layer and the plating layer are formed. At this time, there is a concern about occlusion of hydrogen in the first internal electrode 25 and the second internal electrode 26, but according to the present embodiment, the diffusion regions 29 are formed in the outer peripheral portions of the first internal electrode 25 and the second internal electrode 26, and thus occlusion of hydrogen in the first internal electrode 25 and the second internal electrode 26 is suppressed. The base layer of the external electrode may be formed by a method of applying an electrode paste for the external electrode and sintering the electrode paste after the firing step.

### [Variation]

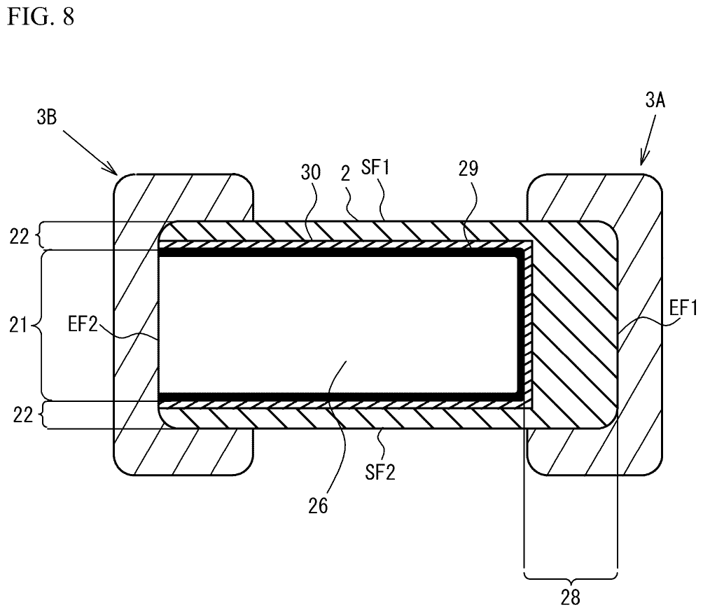

Here, another manufacturing method will be described with reference to FIGS. 7A to 7C. In the above manufacturing method, the additive for forming the diffusion region 29 is added to the thickness compensation material for forming the thickness compensation portion 53 illustrated in FIGS. 6A and 6B. In contrast, in this variation, a dielectric green sheet 61 is prepared (see FIG. 7A), and an additional printed portion 63 is provided around an internal electrode pattern 62 (see FIG. 7B) disposed on the dielectric green sheet 61 (see FIG. 7C). In this variation, the material forming the additional printed portion 63 is at least one metal selected from Pt, Pd, Au, Ag, Cu, Sn, Fe, Zn, and Al, or a material composition containing an oxide of such a metal as a main component. In addition, a thickness compensation portion 64 for compensating for a step difference between the internal electrode pattern 62 and the additional printed portion 63 is provided around the additional printed portion 63. The element that is the main component of the additional printed portion 63 is not added to the thickness compensation portion 64, and the thickness compensation portion 64 is formed using ceramic powder of barium titanate as the main component. The additional printed portion 63 forms a metal containing portion 30 in contact with the outer peripheral portions of the second internal electrode 26 and the outer peripheral portion of the first internal electrodes 25 illustrated in FIG. 8 through the firing of step S3 in the flowchart illustrated in FIG. 5. The metal containing portion 30 contains a metal different from the main component of the first internal electrode 25 and the second internal electrode 26 as a main component. In the present variation, the thickness compensation portion 64 forms an outer peripheral dielectric portion by being fired. The outer peripheral dielectric portion is provided in contact with the outer peripheral portion of the metal containing portion 30 that is not in contact with the first internal electrode 25 or the second internal electrode 26. The outer peripheral dielectric portion is formed of a material having a composition different from that of the metal containing portion 30. The outer peripheral dielectric portion of the present embodiment is formed of a material having a composition common to that of the dielectric layer 27.

The above-mentioned elements present in the diffusion region have the following characteristics. Pt and Au are less likely to be oxidized and are therefore likely to remain as metals, which reduces the ESR of the component and improves the continuity of the internal electrodes. Further, Pd, Ag, and Cu are likely to absorb hydrogen, and thus more effectively suppress deterioration of the insulation resistance. Sn, Fe, Zn, and Al have an effect of improving the continuity of the internal electrode.

The multilayer ceramic capacitor 1 according to the present embodiment includes the diffusion regions 29 including a metal different from the main component of the first internal electrode 25 and the second internal electrode 26 in the outer peripheral portions of the first internal electrode 25 and the second internal electrode 26. This can suppress the deterioration of the insulating resistance value due to the penetration of hydrogen from the external electrodes 3A and 3B into the first internal electrode 25 and the second internal electrode 26.

In addition, the occurrence of current leakage between the electrodes can be suppressed.

### Working Examples

Next, examples will be described in comparison with Comparative Examples. As samples that embody the embodiment of the present application, Examples 1 to 17 were prepared, and Comparative Examples 1 and 2 were prepared. The number of samples of each of examples and comparative Examples was 1000. Then, an IR failure occurrence rate, that is, a occurrence frequency of IR deterioration (deterioration of insulation resistance) in 1000 samples was examined for each of the examples and the comparative examples by a test. In the test, a pressure resistance test in which a 10 V was applied to each sample under the conditions of a temperature of 85 degrees Celsius. and a relative moisture of 85% was performed for 100 hours, and then the number of samples in which the 100 MΩ was equal to or less for 60 seconds was counted, and the number of samples was expressed as the number of IR defects in 1000 samples. Examples 1 to 8 and Examples 12 to 17 were manufactured by the manufacturing method illustrated in FIGS. 6A and 6B, that is, the method in which the additive for forming the diffusion region 29 was added to the thickness compensation portion 53. In contrast, Examples 9 and 10 were manufactured by the manufacturing method illustrated in FIGS. 7A to 7C, that is, a method of adding an additive for forming the diffusion region 29 by printing the additional printed portion 63. The internal electrodes of the examples contained nickel as a main component.

In the diffusion region 29, a predetermined additive metal was confirmed. In the diffusion region 29, nickel, which is a component of the internal electrode, was also confirmed.

The size of the samples of Examples 1 to 11 and Comparative Example 1 illustrated in Table 1 was set such that length L[1]×width W[1]×height H[1] of the multilayer ceramic capacitor 1 illustrated in FIG. 1 was 0.4 mm×0.2 mm×0.2 mm. As for each size of the first internal electrode 25 and the second internal electrode 26, L[25] (L(26))×W[25] (W(26)) illustrated in FIG. 2A and FIG. 4A was set to 0.3 μm×0.1 μm.

The size of the samples of Examples 12 to 17 and Comparative Example 2 illustrated in Table 2 was set such that length L[1]×width W[1]×height H[1] of the multilayer ceramic capacitor 1 illustrated in FIG. 1 was 0.25 mm×0.125 mm×0.125 mm. Each size of the first internal electrode 25 and the second internal electrode 26 were set such that L[25] (L(26))×W[25] (W(26)) illustrated in FIG. 2A and FIG. 4A was 0.16 mm×0.07 mm.

The metal elements forming the diffusion region 29 in Examples 1 to 11 are as illustrated in Table 1. Comparative Example 1 does not include a diffusion region. The metal elements forming the diffusion region 29 in Examples 12 to 17 are as illustrated in Table 2. Comparative Example 2 does not include a diffusion region.

The metal elements contained in the diffusion region 29 other than the composition of the internal electrode are listed as follows. The metal element in the Example 1 was Au. The metal element in Example 2 was Fe. The metal element in Example 3 was Sn. The metal element in Example 4 was Pt. The metal elements in Example 5 were Au and Fe. The metal elements in Example 6 were Sn and Fe. The metal element in Example 7 was Cu. The metal element in Example 8 was Pd. The metal element in Example 9 was Au. The metal element in Example 10 was Sn. The metal elements in Example 11 were Au and Fe. The metal element in Example 12 was Au. The metal element in Example 13 was Fe. The metal element in Example 14 was Sn. The metal element in Example 15 was Pt. The metal elements in Example 16 were Au and Fe. The metal elements in Example 17 were Sn and Fe.

The ranges and average values of the size L[29] (see FIG. 2B) and the size W[29] (see FIG. 4B) of the diffusion region in Examples 1 to 11 are as illustrated in Table 1. The ranges (minimum value to maximum value) and average values of the size L[29] (see FIG. 2B) and the size W[29] (see FIG. 4B) of the diffusion region in Examples 12 to 17 are as illustrated in Table 1. The measurement of the size L[29] and the size W[29] was performed by extracting five samples from 1000 samples and measuring the sizes at arbitrary 10 points in a cross section as illustrated in FIG. 2A or a cross section as illustrated in FIG. 4A. The minimum and maximum of the sizes L[29] and W[29] of the diffusion region are the minimum and maximum values among the numerical values measured in this manner. The average value of the size L[29] and the size W[29] of the diffusion region is calculated as the average value of the numerical values measured in this manner. Since there was no difference in the average value, the maximum value, and the minimum value between the size L[29] and the size W[29], the average value, the maximum value, and the minimum value were calculated without distinguishing therebetween.

The range and average value of the size of the diffusion region in each example are listed as follows. The range of the size of Example 1 was 0.1 nm or more and 1.8 nm or less, and the average value was 1.2 nm. The range of the size of Example 2 was 0.1 nm or more and 1.9 nm or less, and the average value was 1.3 nm. The range of the size of Example 3 was 0.2 nm or more and 2.0 nm or less, and the average value was 1.6 nm. The range of the size of Example 4 was 0.1 nm or more and 3.1 nm or less, and the average value was 2.5 nm. The range of the size of Example 5 was 0.1 nm or more and 2.7 nm or less, and the average value was 1.9 nm. The range of the size of Example 6 was 0.1 nm or more and 3.3 nm or less, and the average value was 2.2 nm. The range of the size of Example 7 was 0.1 nm or more and 1.9 nm or less, and the average value was 1.4 nm. The range of the size of Example 8 was 0.1 nm or more and 1.9 nm or less, and the average value was 1.3 nm. The range of the size of Example 9 was 1 μm or more and 13 μm or less, and the average value was 9.0 μm. The range of the size of Example 10 was 0.8 μm or more and 18 μm or less, and the average value was 11.7 μm. The range of the size of Example 11 was 1.1 μm or more and 16 μm or less, and the average value was 10.9 μm. The range of the size of Example 12 was 0.1 or more and 2.0 nm or less, and the average value was 1.3 nm. The range of the size of Example 13 was 0.1 or more and 2.2 nm or less, and the average value was 1.3 nm. The range of the size of Example 14 was 0.2 or more and 2.2 nm or less, and the average value was 1.7 nm. The range of the size of Example 15 was 0.1 nm or more and 3.0 nm or less, and the average value was 2.1 nm. The range of the size of Example 16 was 0.1 or more and 2.7 nm or less, and the average value is 1.9 nm. The range of the size of Example 17 was 0.1 nm or more and 3.5 nm or less, and the average value was 2.4 nm.

As a result of the test performed in this manner, no IR failure occurred in any of Examples 1 to 17. In contrast, in Comparative Example 1, IR failure was observed in three samples among 1000 samples, and in Comparative Example 2, IR failure was observed in seven samples among 1000 samples.

From the above results, it was confirmed that the diffusion region 29 suppresses the IR failure regardless of the type of metal added and regardless of the manufacturing method thereof.

TABLE 1

| | | SIZE OF METAL COMPOSITION | | |
|---|---|---|---|---|
| | ADDITIVE | FROM MINIMUM | AVERAGE | NUMBER OF |
| | METAL | TO MAXIMUM | VALUE | IR FAILURE |
| EXAMPLE 1 | Au | FROM 0.1 nm | 1.2 nm | 0/1000 |
| | | TO 1.8 nm | | |
| EXAMPLE 2 | Fe | FROM 0.1 nm | 1.3 nm | 0/1000 |
| | | TO 1.9 nm | | |
| EXAMPLE 3 | Sn | FROM 0.2 nm | 1.6 nm | 0/1000 |
| | | TO 2.0 nm | | |
| EXAMPLE 4 | Pt | FROM 0.1 nm | 2.5 nm | 0/1000 |
| | | TO 3.1 nm | | |
| EXAMPLE 5 | Au + Fe | FROM 0.1 nm | 1.9 nm | 0/1000 |
| | | TO 2.7 nm | | |
| EXAMPLE 6 | Sn + Fe | FROM 0.1 nm | 2.2 nm | 0/1000 |
| | | TO 3.3 nm | | |
| EXAMPLE 7 | Cu | FROM 0.1 nm | 1.4 nm | 0/1000 |
| | | TO 1.9 nm | | |
| EXAMPLE 8 | Pd | FROM 0.1 nm | 1.3 nm | 0/1000 |
| | | TO 1.9 nm | | |
| EXAMPLE 9 | Au | FROM 1 μm | 9.0 μm | 0/1000 |
| | | TO 13 μm | | |
| EXAMPLE 10 | Sn | FROM 0.8 μm | 11.7 μm | 0/1000 |
| | | TO 18 μm | | |
| EXAMPLE 11 | Au + Fe | FROM 1.1 μm | 10.9 μm | 0/1000 |
| | | TO 16 μm | | |
| COMPARATIVE | NONE | — | — | 3/1000 |
| EXAMPLE 1 | | | | |

TABLE 2

| | | SIZE OF METAL COMPOSITION | | |
|---|---|---|---|---|
| | ADDITIVE | FROM MINIMUM | AVERAGE | NUMBER OF |
| | METAL | TO MAXIMUM | VALUE | IR FAILURE |
| EXAMPLE 12 | Au | FROM 0.1 nm | 1.3 nm | 0/1000 |
| | | TO 2.0 nm | | |
| EXAMPLE 13 | Fe | FROM 0.1 nm | 1.3 nm | 0/1000 |
| | | TO 2.2 nm | | |
| EXAMPLE 14 | Sn | FROM 0.2 nm | 1.7 nm | 0/1000 |
| | | TO 2.2 nm | | |
| EXAMPLE 15 | Pt | FROM 0.1 nm | 2.1 nm | 0/1000 |
| | | TO 3.0 nm | | |
| EXAMPLE 16 | Au + Fe | FROM 0.1 nm | 1.9 nm | 0/1000 |
| | | TO 2.7 nm | | |
| EXAMPLE 17 | Sn + Fe | FROM 0.1 nm | 2.4 nm | 0/1000 |
| | | TO 3.5 nm | | |
| COMPARATIVE | NONE | — | — | 7/1000 |
| EXAMPLE 2 | | | | |

In each of the above-described embodiments, the multilayer ceramic capacitor has been described as an example of a multilayer ceramic electronic component, but the present embodiment is not limited thereto. For example, the configurations of the above-described embodiments are applicable to other multilayer ceramic electronic components such as varistors and thermistors.

The above embodiments are merely examples for carrying out the present disclosure, and the present disclosure is not limited to these embodiments. It is to be understood that the various change, substitutions, and alterations could be made hereto without departing from the spirit and scope of the disclosure.

What is claimed is:

1. A multilayer ceramic electronic component comprising:
a ceramic element having dielectric layers and internal electrodes alternately laminated in a first axis direction, a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction;
a pair of external electrodes respectively provided at end portions of the ceramic element in the third axis direction and electrically connected to the internal electrodes respectively led out to the end portions of the ceramic element in the third axis direction;
a metal containing portion provided in contact with an outer peripheral portion of the internal electrode when viewed from the first axis direction, and formed of a material containing a metal, as a main component, different from a main component of the internal electrode; and
an outer peripheral dielectric portion provided between the dielectric layers respectively disposed on an upper surface and a lower surface of the internal electrode along the first axis direction, provided in contact with an outer peripheral portion of the metal containing portion not in contact with the internal electrode when viewed from the first axis direction, and formed of a material having a composition different from that of the metal containing portion,
wherein
the internal electrode includes a diffusion region including a metal different from a main component of the internal electrode in at least a portion of an outer peripheral portion of the internal electrode,
the diffusion region is formed at an end portion of the internal electrode in the second axis direction in a cross section parallel to a plane including the first axis direction and the second axis direction, or is formed at an end portion of the internal electrode in the third axis direction in a cross section parallel to a plane including the first axis direction and the third axis direction, and
a concentration of any element of Pt, Pd, Au, Ag, Cu, Sn, Fe, Zn, or Al in the diffusion region is higher than that in the upper surface and the lower surface of the internal electrode.

2. The multilayer ceramic electronic component according to claim 1, wherein
when the diffusion region is formed at the end portion of the internal electrode in the second axis direction in the cross section parallel to the plane including the first axis direction and the second axis direction, a size of the diffusion region in a direction along the second axis direction is 0.1 nm or more and 37 μm or less.

3. The multilayer ceramic electronic component according to claim 1, wherein
when the diffusion region is provided at the end portion of the internal electrodes in the second axis direction in the cross section parallel to the plane including the first axis direction and the third axis direction, a size of the diffusion region in a direction along the third axis direction is 0.1 nm or more and 37 μm or less.

4. The multilayer ceramic electronic component according to claim 1, wherein
the multilayer ceramic electronic component has outer sizes of 2.8 mm or less in each of the first axis direction and the second axis direction and 6.1 mm or less in the third axis direction.

5. The multilayer ceramic electronic component according to claim 1, wherein
the internal electrode contains Ni as a main component, and Ni is present in the diffusion region.

6. The multilayer ceramic electronic component according to claim 1, wherein
when the diffusion region is provided at the end portion of the internal electrodes in the second axis direction in the cross section parallel to the plane including the first axis direction and the third axis direction, a size of the diffusion region in a direction along the third axis direction is 0.1 nm or more and 3.5 nm or less.

7. The multilayer ceramic electronic component according to claim 1, wherein
when the diffusion region is formed at an end portion of the internal electrode in the second axis direction in the cross section parallel to the plane including the first axis direction and the third axis direction, a size of the diffusion region in a direction along the third axis direction is 0.8 μm or more and 18 μm or less.

8. A method of manufacturing a multilayer ceramic electronic component, comprising:
a first step of disposing an internal electrode pattern of a metal conductive paste on a green sheet containing main component ceramic particles;
a second step of forming, as an additional printed portion, a metal containing portion including, together with the main component ceramic particles, at least a metal of Pt, Pd, Au, Ag, Cu, Sn, Fe, Zn, or Al, or an oxide of the metal in a peripheral region of the metal conductive paste on the green sheet, and providing, as a thickness compensation portion, an outer peripheral dielectric portion for compensating for a step between the internal electrode pattern and the additional printed portion in a periphery of the additional printed portion not in contact with the internal electrode;
a third step of firing a ceramic laminate body obtained by laminating a plurality of lamination units obtained in the second step; and
a fourth step of subjecting the ceramic laminate body obtained in the third step to a plating treatment to form an external electrode.
